(19) United States
(12) Patent Application Publication
(10) Pub. No.: US 2011/0270686 A1
(43) Pub. Date: Nov. 3, 2011

(54) ONLINE PLATFORM FOR WEB ADVERTISEMENT PARTNERSHIPS

(75) Inventors: PRITESH PATWA, Redmond, WA (US); WOOK CHUNG, Kirkland, WA (US)

(73) Assignee: MICROSOFT CORPORATION, REDMOND, WA (US)

(21) Appl. No.: 12/769,406

(22) Filed: Apr. 28, 2010

(51) Int. Cl. G06Q 30/00

(52) U.S. Cl. 705/14.66

(57) ABSTRACT

Embodiments of the present invention relate creating online advertising co-campaigns between multiple web advertisers. Users affiliated with different entities looking to advertise online can easily submit requests to form the co-campaigns. The partner advertisers the users request to form co-campaigns with can then be messaged and asked whether the partner advertisers will agree to the online advertising partnership. A co-campaign will be created and managed if the partner advertisers agree to take part in the co-campaign. Co-campaigns are possible for online one-to-one, many-to-one, and many-to-many advertising partnerships online.

### BACKGROUND

The proliferation of the World Wide Web has made it a lucrative frontier for advertising. Web pages receiving thousands or millions of visitors are proving to be viable advertising platforms. Banner ads, sky-scraper ads, and other interactive online ads provide the web page purveyors with substantial revenue streams and act as gateways to advertisers' products, services, and web sites. As different media quickly moves to the Internet, advertisers have proven that their advertisements will follow.

Although, advertisers do not have the same luxuries in the online world that they have offline. Two or more advertisers getting together to support a cross-promotion of their products or services in offline media outlets requires time-consuming meetings of marketing managers and other advertising personnel for the companies meeting, mapping out the cross-promotion, agree on release dates, and execute a strategic marketing plan. While the Internet streamlines the communication of ideas in many ways, cross-promotional and collaborative advertising between multiple companies still requires marketing teams from the companies creating and agreeing on marketing promotions. To run a web advertisement that furthers the marketing interests of the companies, the companies have to agree on a suitable advertisement, web page for the advertisement, and location on the web page. The required collaboration between the two companies over the advertisement can be quite time consuming and tedious.

Numerous web services currently exist for storing web advertisements and determining when and where to present the web advertisements. Often, these services act like online auctions, constantly comparing bid amounts and other metrics for displaying the web advertisements. For example, advertiser A may choose to pay X dollars for displaying its advertisement on a web page banner ad to viewers of the web page who fit a particular socioeconomic profile (e.g., certain gender, age, race, geographic location, etc.). Thus, advertisers get to select who to show their advertisements to and how much to pay to show the advertisements to those Internet users.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments are generally directed towards creating and managing online advertising co-campaigns between multiple advertisers. One aspect is directed towards using an application server to receive a request to create a co-campaign from a user Affiliated with an advertiser. The requests may include a particular web advertisement, bid amount, and plurality of user-profile metrics. From the request, the application server determines a partner advertiser the user wishes to create the co-campaign with. A user Affiliated with the partner advertiser is informed of the request and asked whether the partner advertiser would like to create the co-campaign. If so, the application server creates, stores, and manages the newly formed co-campaign between the advertiser and the partner advertiser. If not, a rejection message may be sent to the user, notifying the user that the partner advertiser has no desire to form the co-campaign.

Another aspect is directed towards creating online combination advertisements (combo ads) between two advertisers. The combo ads may be created by either advertiser or both sides in collaboration and are used in a co-campaign that an advertiser and a partner advertiser agree to develop.

Still another aspect is directed towards sharing user-profile metrics currently be used by a partner advertiser in an online advertising campaign with another advertiser. Providing the second advertiser access to the user-profile metrics allows the second advertiser to use the partner advertiser's user-profile metrics when deciding to whom to display its own online advertisements.

Embodiments mentioned herein are not limited, however, to auction-based advertisement platforms used primarily for search or contextual advertisements. Alternatively, some embodiments use online display advertisements (e.g., banner, picture, or video advertisements) that are mostly based on time-table bookings, meaning the advertisements do not compete in an auction but instead are purchased by the impression. In other words, an advertiser may elect to run an advertisement campaign with the display advertisements for a set number of impressions during a particular time frame (e.g. day, hour, etc.) on a particular web page.

### BRIEF DESCRIPTION OF THE SEVERAL VIEWS OF THE DRAWINGS

Illustrative embodiments of the present invention are described in detail below with reference to the attached drawing figures:

FIG. 1 illustrates an exemplary computing device, according to one embodiment;

FIG. 2 is block diagrams of different relationships between advertisers, according to one embodiment;

FIG. 3 is a block diagram of a networking environment configured to create and manage co-campaigns, according to one embodiment;

FIG. 4 is a block diagram illustrating two users at two different companies forming a co-campaign online, according to one embodiment;

FIG. 5 is an interactive block diagram showing the flow of active between multiple devices in order to create and manage a co-campaign, according to one embodiment;

FIG. 6 illustrates a tabular representation of ad campaigns and co-campaigns, according to one embodiment; and

FIG. 7 is a diagram of a flow chart for creating a co-campaign, according to one embodiment.

### DETAILED DESCRIPTION

The subject matter of embodiments of the present invention is described with specificity herein to meet statutory requirements. Although the terms “step,” “block” or “module” might be used to connote different components of embodiments described herein, these terms should not be interpreted as implying any particular sequential order between various steps, unless the order of individual steps is explicitly described.

Embodiments described herein generally relate to creating and managing advertisement co-campaigns between multiple advertisers. The embodiments allow multiple advertisers to partner together in an online effort to either's web advertisement campaigns, to create a collaborative web advertisement, or share user-profile metrics of current online advertisement campaigns. In particular, a company may desire to help the chances that another company's web advertisement is displayed to users because the former's products and services are included in the latter's products or services. For example, a software provider may have an interest in seeing a computer manufacturer sell more of its computers because the computers are pre-installed with the software company's operating system (OS). Or, to further illustrate the point, a company making a particular cell phone may want to help a cell phone service provider sign up new subscribers because the company exclusively sells its phones through the cell phone provider. Other types of advertising partnerships are also possible.

To clarify the embodiments described here, a number of terms should be defined. First, an “advertiser” refers to any company, organization, or individual looking to display advertisements on web pages, which include can include results pages of search engines. Typically, advertisers, or agents acting on their behalf, will register with and use different advertising web services (e.g., Microsoft® AdCenter or AdExpert, Google® AdSense or AdWords, and the like) to identify areas on web pages for displaying the advertiser's web advertisements, and also when to display the web advertisements—i.e., when a particular type of user views the web page, searches for a particular query on a search engine, etc.

The advertisement web services may consider various user-profile metrics in selecting web advertisement to display on which web page and to which user. While not an exhaustive list, these metrics may include: click-thru rates (CTR), bid amounts, advertisement designs and layouts, viewers' ages, viewers' locations, viewers' genders, viewers' races, viewers' web histories, and other types of viewer engagement parameters. Viewer locations can be ascertained in any number of well-known ways, such as cell phone triangulation, reverse Internet Protocol (IP) address lookup, global positioning system (GPS), or the like. Click-thru rates may include the number or percentage of times a user or group of users selects—or “clicks”—a particular web advertisement. Viewers' web histories include the tracking of web pages that a user or group of users has historically visited and or the viewers' search query history on a particular search engine.

A “campaign,” as referred to herein, is a specific, pre-defined set of advertising metrics and their association with a web advertisement of an advertiser. For example, advertiser A may register with a web advertising service to only display a particular web advertisement to users that fit a profile of metrics the advertiser wishes to reach. In other words, the advertiser selects the advertisement and the metrics making up the profile of the users to show the advertisement to on the web page.

A “co-campaign,” as referred to herein, is a campaign being run by two or more advertisers. In one embodiment, a co-campaign consists of one advertiser adding money to the bid amounts of another company's campaign. For example, Microsoft® may wish to form a co-campaign with Hewlett Packard®, because Hewlett Packard® computers are pre-installed with the latest version of Microsoft Windows®. In this embodiment, Microsoft® can form a co-campaign with Hewlett Packard® and simply add to the current bid amounts Hewlett Packard® is willing to pay in one or more campaigns for Hewlett Packard®'s web advertisements. For instance, if Hewlett Packard® was willing to pay X dollars to display a web advertisement on a particular web page to users of a certain profile, Microsoft® could pay Y dollars to the bid amount, resulting in an X+Y dollar bid amount. In effect, Microsoft®'s contribution to Hewlett Packard®'s bid amount will increase the chances that Hewlett Packard®'s web advertisement is selected by a web advertisement service for display. Consequently, Microsoft® would indirectly benefits because a product with Windows® has been given a better chance for advertisement exposure.

Campaigns and co-campaigns may compete in auction-based or display-based advertisement platforms. The former contemplates a plethora of advertisers—or combinations of advertisers—competing for advertisement spaces on a web page primarily through bid amounts. The latter, on the other hand, uses online display advertisements (e.g., banner, picture, or video advertisements) that are mostly based on time-table bookings, meaning the advertisements purchased by the impression or click-thru rate instead of through an bid-amount auction. In other words, an advertiser may elect to run an advertisement campaign with the display advertisements for a set number of impressions during a particular time frame (e.g. day, hour, etc.) on a particular web page.

Embodiments mentioned herein may take the form of a computer-program product that includes computer-useable instructions embodied on one or more computer-readable media. Computer-readable media include both volatile and nonvolatile media, removable and nonremovable media, and contemplate media readable by a database. The various computing devices, application servers, and database servers described herein each may contain different types of computer-readable media to store instructions and data. Additionally, these devices may also be configured with various applications and operating systems.

By way of example and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory devices can store data momentarily, temporarily, or permanently.

Various techniques are performed by web-based services that support interoperable machine-to-machine interaction over a network. For the sake of clarity, the server-based web services described herein are referred to as “components.” Components may operate in a client-server relationship to carry out various techniques described herein. Such computing is commonly referred to as “in-the-cloud” computing. To support components, servers may be configured with a server-based OS.

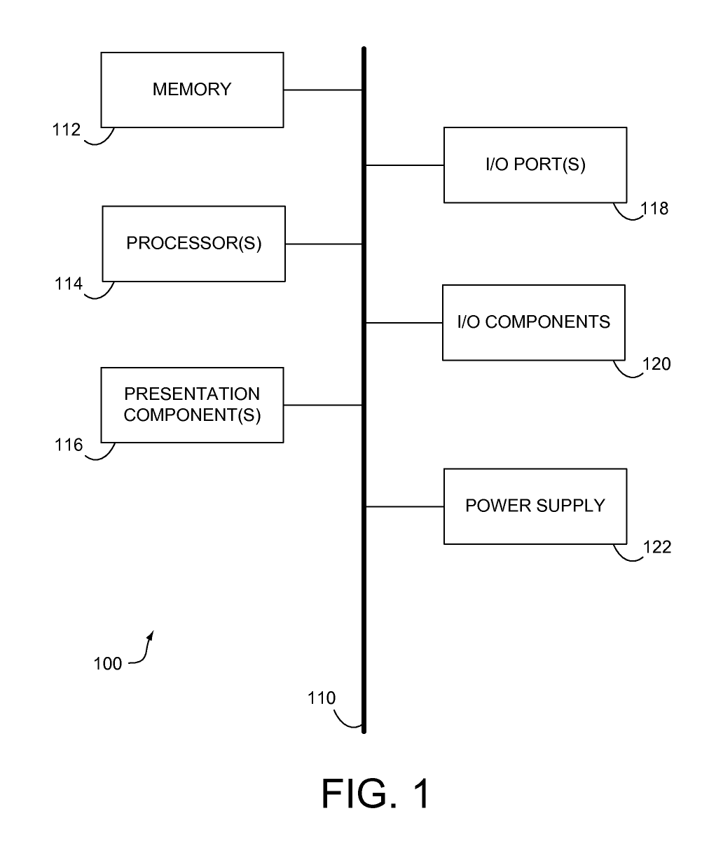

Having briefly described a general overview of the embodiments described herein, an exemplary operating environment is described below. Referring initially to FIG. 1 in particular, an exemplary operating environment for implementing one embodiment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of illustrated component parts. In one embodiment, computing device 100 is a personal computer. But in other embodiments, computing device 100 may be a cell phone, smart phone, digital phone, handheld device, BlackBerry®, personal digital assistant (PDA), or other device capable of executing computer instructions.

Embodiments may be described in the general context of computer code or machine-useable instructions, including computer-executable instructions such as program modules, being executed by a computer or other machine, such as a PDA or other handheld device. Generally, machine-useable instructions define various software routines, programs, objects, components, data structures, remote procedure calls (RPCs), and the like. In operation, these instructions perform particular computational tasks, such as requesting and retrieving information stored on a remote computing device or server.

Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation device 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various hardware is not so clear, and metaphorically, the lines would more accurately be grey and fuzzy. For example, one may consider a presentation device, such as a monitor, to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 may include a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation device 116 presents data indications to a user or other device. Exemplary presentation components include a display device, speaker, printing component, vibrating component, etc.

Specifically, memory 112 may be embodied with instructions for a web browser application, such as Microsoft Internet Explorer®. One skilled in the art will understand the functionality of web browsers; therefore, web browsers need not be discussed at length herein. It should be noted, however, that the web browser embodied on memory 112 may be configured with various plug-ins (e.g., Microsoft SilverLight™ or Adobe Flash). Such plug-ins provide enable web browsers to execute various scripts or mark-up language in communicated web content. For example, a JavaScript may be embedded within a web page and executable on the client computing device 100 by a web browser plug-in.

I/O ports 118 allow computing device 100 to be logically coupled to other devices including I/O components 120, some of which may be built in. Illustrative components include a microphone, joystick, game pad, satellite dish, scanner, printer, wireless device, etc.

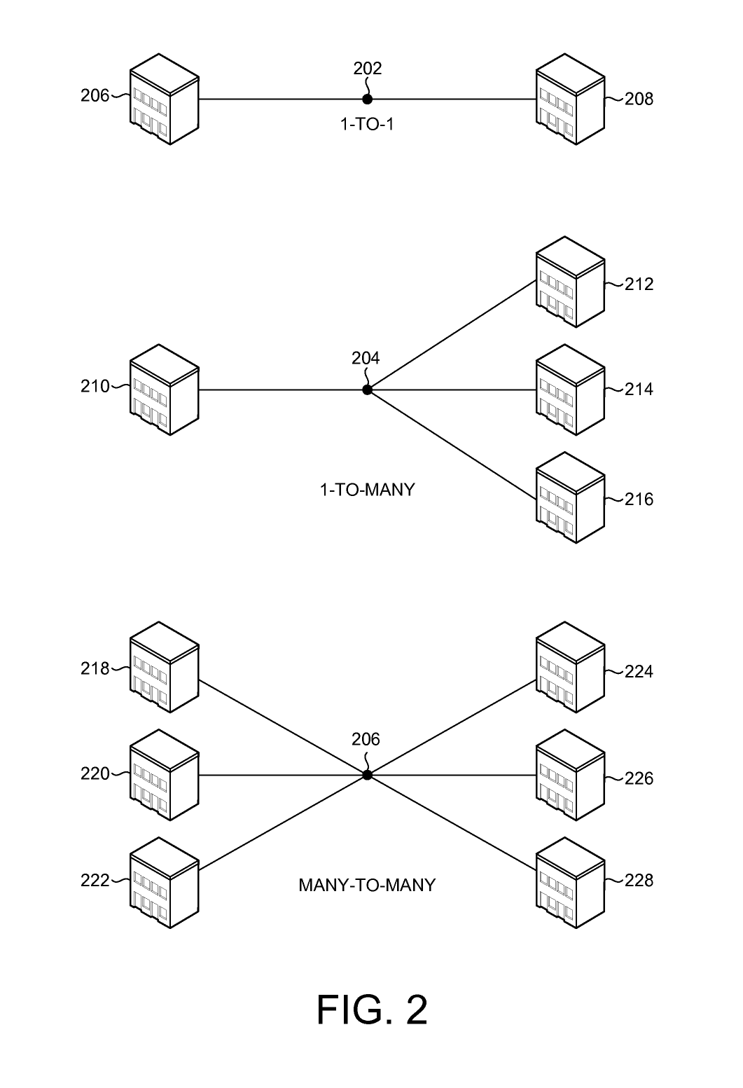

FIG. 2 is block diagrams of different relationships between advertisers, according to one embodiment. Embodiments are not limited to co-campaigns between only two advertisers. In partnership 202, advertisers 204 and 206 have a one-to-one (1-1) co-campaign relationship. A one-to-one co-campaign relationship means that advertisers 204 and 206 are the only participants of the co-campaign. So advertiser 204 can boost the bid amount of advertiser 206's campaigns, in one embodiment. In another embodiment, advertiser 204 can collaborate with advertiser 206 in an online space to develop a web advertisement and/or campaign for the web advertisement together. In still another embodiment, advertiser 204 can request that advertiser 206 share the profile metrics that advertiser 206 is using in different campaigns. If advertiser 206 agrees to share, the user-profile metrics will be supplied to advertiser 204, allowing advertiser 204 to create a co-campaign consisting of the shared user metrics and a bid amount specified by advertiser 204.

Three types of co-campaigns will repeatedly be referenced herein. In fact, embodiments may include any of these three co-campaigns. To clarify, the three types of co-campaigns will be defined. The first, when advertiser 204 increments the bid amount advertiser 206 is currently bidding for a campaign, will be referenced as a “bid-boost” or “bid-boosting campaign.” The second, when advertisers 204 and 206 collaborate on a web advertisement, will be referenced as a “combo ad.” The third, when advertiser 206 shares user-profile metrics with advertiser 204 so advertiser 204 may use the shared user-profile metrics to create a campaign of its own, will be referenced as a “share-metrics” or “request-metrics” campaign. These reference names are provided to clarify the different types of co-campaigns contemplated by the embodiments discussed herein; however, the reference names are not meant to limit the co-campaigns in any way.

Particularly, a combo ad may be created by two or advertisers passing an advertisement and/or metrics for a co-campaign back and forth until all advertisers agree on the advertisement to be used and the metrics for targeting web advertisement opportunities. In one embodiment, a centralized server (such as the campaign servers mentioned herein) facilitates communications between the different advertisers, transmitting one advertisers modifications of a draft advertisement to other partner advertisers. Additionally, the centralized server may also communicate different metrics the advertiser wishes the co-campaign to target. For example, suppose a car manufacturer wishes to create a co-campaign with all its dealers in a particular geographic area. The car manufacturer may initially propose a draft of a particular online advertisement and send the draft to all of dealers along with user-profile metrics to which to advertise. Each dealer can then modify the online advertisement and user-profile metrics to make the online advertisement more efficient. This back-and-forth interaction may continue until all of the car manufacturer and the dealers create an advertisement user-profile metrics all advertisers can agree upon and used in the co-campaign.

For a share-metrics co-campaign, a potential partner advertiser's (or advertisers') user-profile metrics may be requested by an advertiser. In essence, the advertiser is asking to use the user-profile metrics for targeting users for the advertiser's own advertisements. Alternatively, the advertiser may just want to follow the potential partner advertiser's lead in targeting users—for instance, when the user-profile metrics are confidential to the potential partner advertiser. In this situation, the advertiser may request the user-profile metrics for a particular product, service, or ad campaign, and if the request is accepted by the potential partner advertiser, the specific user-profile metrics can be used by the advertiser for targeting purposes. As a condition of the co-campaign, the potential partner advertiser may wish to keep the user-profile metrics secret, and thus create a co-campaign where the advertiser can only use the user-profile metrics but not know them.

Advertisers may alternatively choose to not show particular advertisements based on a partner advertiser's advertisement already being shown. In this embodiment, an advertiser may choose to show a different advertisement image when positioned next to partner advertiser's advertisement. For example, AT&T® could show an advertisement for a particular mobile phone whenever the mobile phone's company is not similarly also advertising on the web page, but when the mobile phone company also is showing an advertisement, AT&T® may elect to show a different advertisement that does not include the mobile phone. This scenario ensures that viewer is not inundated with multiple advertisements for the same product—which, in some advertising scenarios, may be detrimental to AT&T® and the mobile phone company's advertising agendas.

Co-campaigns be conditioned on different rules based on the advertisements being shown on a web page. For instance, both Microsoft® and Hewlett Packard® may each have their own campaigns that are bidding the keyword “laptop.” The two may also have a co-campaign that likewise bids on the keyword “laptop.” A scenario may then result in Microsoft®, Hewlett Packard®, and their co-campaign being the top three campaigns for an advertisement spot on the web page. Instead of merely showing all three advertisements—one from Microsoft®'s sole campaign, one from Hewlett Packard®'s sole campaign, and one from the co-campaign—, the co-campaign may include rules that condition it to only trigger when neither a Microsoft® or Hewlett Packard® campaign are already selected for display on the web page, thus alleviating duplicate advertisements for each advertiser. In essence, one advertiser may construct either campaigns or co-campaigns that only display advertisements when other campaigns or co-campaigns of the advertiser are not already being chosen for display on the web page.

Campaign management is also important in the selection and creation of co-campaigns. Once created, a co-campaign may later be modified by different advertisers. For example, partner advertisers may agree on a specific price for a product and choose an advertisement in a co-campaign advertising that price. Upon hearing of a competitive product's recent price drop, the partner advertisers may quickly change the co-campaign to include an advertisement that advertises the product's features instead of price. One skilled in the art will appreciate that numerous other scenarios for changing co-campaigns, without having to create new ones, are also contemplated by the embodiments herein.

Alternatively, co-campaigns may be created in such a manner to not allow modifications ever or for during certain pre-agreed upon time periods. For example, two advertisers may create a co-campaign that shows an advertisement to a particular group of users for a month, and the co-campaign, once created, may not be changed by either advertiser during the month. One skilled in the art will appreciate that numerous other scenarios for restricting changes to co-campaigns are also contemplated by the embodiments herein.

Advertisers may form co-campaigns that allow multiple advertisers to form different relationships. FIG. 2 is block diagram showing different relationships between advertisers, according to one embodiment. Specifically, embodiments may include co-campaigns organized in a one-to-one (1-to-1), one-to-many (1-to-many), or many-to-many relationship, illustrated as relationships 202, 204, and 206, respectively. In particular, relationship 202 illustrates a 1-to-1 relationship between advertisers 206 and 208. Relationship 204 illustrates a 1-to-many relationship between advertisers 210, 212, 214, and 216. Relationship 206 illustrates a many-to-many relationship between advertisers 218, 220, 222, 224, 226, and 228. Relationships 202, 204, and 206 show that a single advertiser may have a co-campaign with one or several advertisers. For example, suppose an online auction has numerous individuals and companies selling their products on the online auction's website. The online auction may then have an interest in promoting web advertisements for the registered individuals and companies, hoping that additional traffic to the registered individuals' and companies' web sites may mean additional web traffic to the online auction—or even better, additional purchases at the online auction.

In particular, relationship 206 illustrates a many-to-many co-campaign. In this relationship, numerous advertisers may contribute to one co-campaign that other advertisers also contribute to. As shown, advertisers 218, 220, and 222 may form a co-campaign with multiple advertisers 224, 226, and 228. For example, several different oil refineries may have an interest to promote several different gas stations in a geographic region that are operated by a particular gasoline distributor. For instance, Chevron®, Exxon Mobil®, and Weber Oil® may want to promote Shell® gasoline, which is sold at multiple different retailers in a certain town. To do so, both the oil companies and gasoline retailers may contribute to a co-campaign that promotes the local gasoline retailers to a user searching online for different gas stations in the town. The local retailers benefit from promoting Exxon Mobil®, Chevron®, and Webber Oil® because doing so helps these three sell oil to Shell®, and thus lower the price of gasoline for the local gasoline retailers.

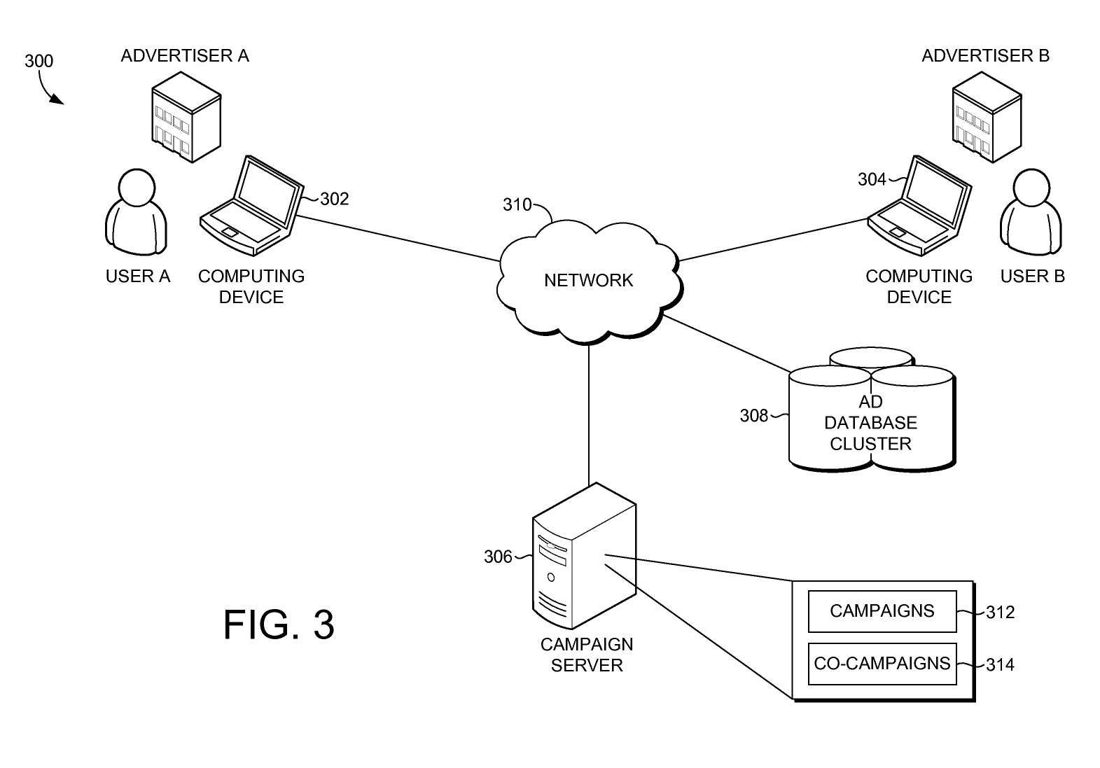

FIG. 3 is a block diagram of a networking environment configured to create and manage co-campaigns, according to one embodiment. As shown, a computing device 302, computing device 304, campaign server 306, and advertisement database (ad database) cluster 308 are communicatively connected across a network 310.

Computing devices 302 and 304 may be any type of computing device, such as the device 100 described above with reference to FIG. 1. By example, without limitation, computing devices 302 and 304 may each be a personal computer, desktop computer, laptop computer, handheld device, mobile phone, electronic tablet, or other personal computing device. In particular, computing devices 302 and 304 may be configured with web browsers capable of rendering web pages on the World Wide Web and accessing different user interfaces (UIs) described herein.

The network 310 may include any computer network, for example the Internet, a private network, local area network (LAN), wide area network (WAN), or the like. One network 310 comprises a LAN networking environment, components may be connected to the LAN through a network interface or adapter. In an embodiment where the network 310 provides a WAN networking environment, components may use a modem to establish communications over the WAN. The network 310 is not limited, however, to connections coupling separate computer units. Instead, the network 310 may also include subsystems that transfer data between a server and the computing devices. For example, the network 310 may include a point-to-point connection. Computer networks are well known to one skilled in the art, and therefore do not need to be discussed at length herein.

The campaign server 306 represents a server (or servers) configured to execute different web-service software components. Campaign server 306 includes a processing unit and computer-storage media storing instructions to create and manage co-campaigns for multiple advertisers. While campaign server 306 is illustrated as a single box, one skilled in the art will appreciate that the campaign server 306 may, in fact, be scalable. For example, campaign server 306 may actually include multiple servers operating various portions of software that collectively create and manage co-campaigns for advertisers. In one embodiment, both ad campaigns 312 and co-campaigns 314 are created, managed, and stored on the campaign server 306.

Ad database cluster 308 represents one or more database servers configured to store and manage databases of information associated with users visiting web pages and also different campaigns and/or co-campaigns. In other words, ad database cluster 308 is a storage dumping ground for information collected from web advertising services (not pictured in FIG. 3 for clarity). Specific to the embodiments discussed herein, ad database cluster 308 includes historical tracking data about user profiles as different users access web pages on the World Wide Web.

It should be noted that the networking environment 300 shows the hardware necessary to establish a one-to-one co-campaign. Additional computing devices and campaign servers may be added to form one-to-many or many-to-many co-campaigns. For the sake of clarity, however, the one-to-one co-campaign is discussed to illustrate several of the embodiments.

In operation, a person sitting at computing device 302 will be attempting to create a co-campaign for advertiser A, which could be the person's employer, organization, blog, business, or other entity. In one embodiment, the person accesses a web page for registering or creating co-campaigns using computing device 302. The web page may be configured to present several options for creating the co-campaign, such as creating a bid boosting, combo ad, or request metrics co-campaign. Also, the web page may provide options for creating any of the aforementioned advertising partnership relationships (one-to-one, one-to-many, and many-to-many).

In one embodiment, the person can select the individual or entity that the person wishes to form the co-campaign with in the web page. In one embodiment, the person simply enters the name of the individual or entity, resulting in the campaign server 306 performing a keyword or context search for individuals or entities stored in the ad database cluster 308. For example, advertiser A may be the Microsoft®, and the person may be a marketing manager for Microsoft®. If the marketing manager wishes to create a co-campaign with Hewlett Packard®, the marketing manager can simply enter “Hewlett Packard” or “HP” into a textbox on the web page and let the campaign server 306 search for entities and individuals who may match HP. Alternatively, the campaign server 306 may be configured to not conduct context or keyword searches of names entered by the person on computing device 302 in an effort by the web-advertisement service to preserve its clients' privacy.

The co-campaign request is sent to the computing device 304, which operates as a terminal for marketing personnel of advertiser B. The personnel can approve or reject the co-campaign request. If approved, the campaign server 306 creates and stores—either locally or remotely—a co-campaign 314 for the advertisers A and B. The creation or management of co-campaign 314 may require the campaign server to access different campaigns 312 stored for advertiser A, advertiser B, or both. For example, if the co-campaign is a bid-boosting co-campaign, co-campaign 314 may comprise the user-profile metrics for one of the campaigns 312 of advertiser B incremented by a bid amount offered by advertiser A. The results would be a co-campaign with the user-profile metrics of a campaign for advertiser B and a bid amount that includes X dollars previously bid by advertiser B plus Y dollars recently bid by advertiser A to boost the bid amount.

Alternatively, in the instance where the co-campaign 314 represents an ad combo, the co-campaign 314 may comprise a collaborative advertisement image or file (e.g., Flash, HTML, or the like). Still, if co-campaign 314 is a share-metrics co-campaign, co-campaign 314 may comprise the user-profile metrics from a campaign 312 of the advertiser B and one or more bid amounts specified by the advertiser A—effectively allowing the advertiser A to bid any amount on the user-profile metrics of a campaign already stored for the advertiser B.

In addition, a share-metrics co-campaign may comprise a web advertisement from advertiser A, instead of advertiser B. Considering the Microsoft®-Hewlett Packard® example detailed above, the user-profile metrics Hewlett Packard® typically uses to display web advertisements about its laptops would be used in a share metrics co-campaign that includes an advertisement for Microsoft® software as well as the Hewlett Packard® user-profile metrics. As a result, Microsoft® web advertisements could be directed towards web visitors Hewlett Packard® has been targeting for its laptops. Or, in another example, Hewlett Packard® might like to build a co-campaign using the user profiles Microsoft® has of users who have older computers. In exchange, Hewlett Packard® may share with Microsoft® the user profiles Hewlett Packard® has of users who have recently purchased Hewlett Packard® machines, and thus may be relevant targets for upgrade offers for different versions of Microsoft Windows®.

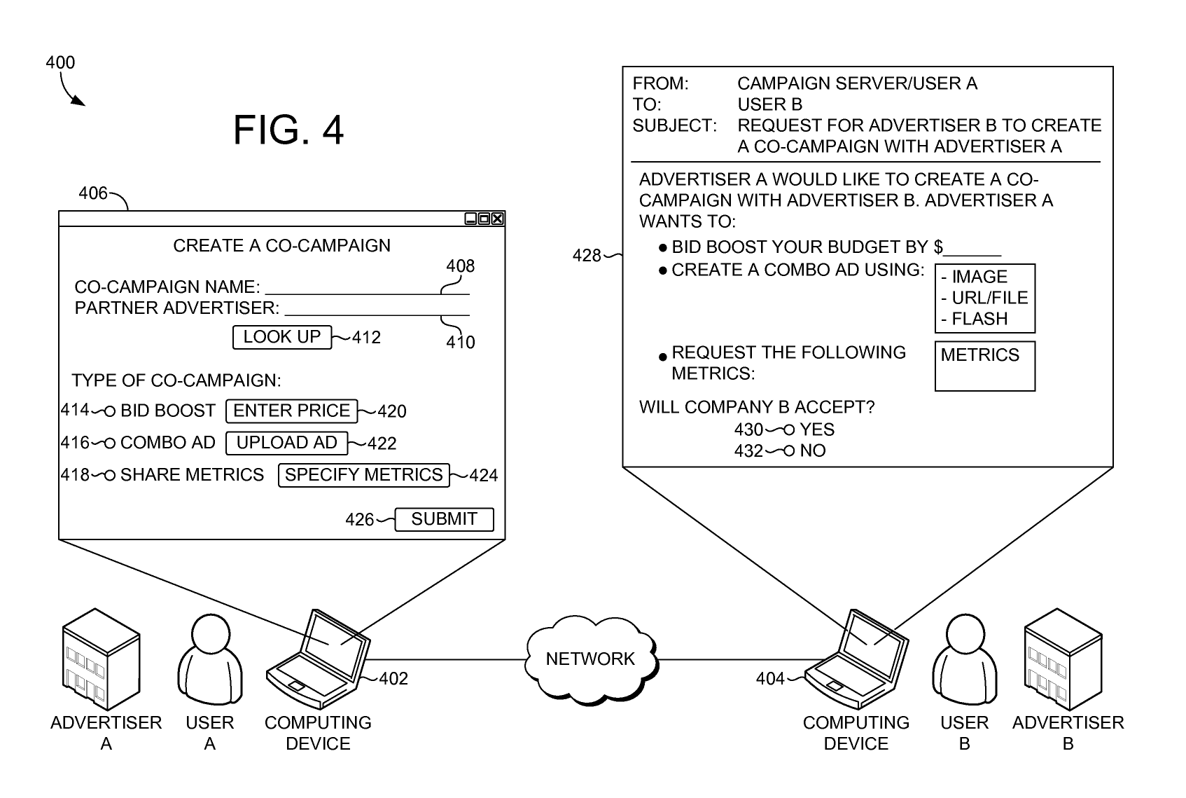

FIG. 4 is a block diagram illustrating two users at two different companies forming a co-campaign online, according to one embodiment. As shown, user A is attempting to create a co-campaign between advertisers A and B. Using computing device 402, user A accesses web page 406, which includes a page to create a co-campaign (i.e., the page that is illustrated). There, user A can enter a name for the co-campaign in text field 408. User A can also specify the partner advertiser—in this case advertiser B—of the co-campaign at textbox 410. If user A does not know the formal name of advertiser B, user A can select the LOOK UP button 412 to trigger the application server to search for known advertisers that may match the name entered into the textbox 410.

Additionally, user A may select the type of co-campaign user A wishes to create by selecting one of the options 414, 416, and 418 for creating a bid-boost, combo ad, or share-metrics co-campaign. Depending on the type of co-campaign selected, user A may elect to enter a bid amount price using button 420, upload an advertisement using button 422, or specify the metrics user A wants to receive using button 424. In the case of a share-metrics co-campaign, one embodiment allows the user to enter a message for delivery to user B that states what advertiser B product or service user A is requesting user-profile metrics for. For example, suppose advertiser A was a tire manufacturer and advertiser B was a car manufacturer that buys advertiser A's tires. User A could send user B a message stating that the tire company would like to use the user-profile metrics the car manufacturer is currently using to identify potential web users to display the car manufacturer's web advertisements to. Once the message is entered, the application server sends the message to user B.

When user A is finished filling out the co-campaign creation form of the web page 406, user A selects the SUBMIT button 426. Consequently, a message 428 is sent to user B detailing user A's request to create a co-campaign between advertiser A and advertiser B. Message 428 may be any type of well-known electronic message, such as, for example but without limitation, an e-mail message, short message service (SMS) message, multimedia messaging service (MMS) message, or the like. Message 428 may include a host of information about the request sent by user A. In the embodiment shown, message 428 states that advertiser A would like to create a co-campaign with advertiser B and specifies what type of action advertiser B proposes.

For a combo ad, message 428 may include an image, text, trademark, logo, URL or file path, or flash file of an initial attempt at the combo ad. Also, in the case of a request to share metrics, the message specified by user A describing the requested product, service, or user-profile metrics may be included. Eventually, user B will be prompted to accept or reject user A's request, using buttons 430 and 432. Rejection of the co-campaign may prompt a message to be sent back to user A that user A's request was denied, and similarly, acceptance of user A's request may also be confirmed through a message back to user A. When user B agrees to create the co-campaign, the application server creates the co-campaign, and afterward, manages the co-campaign—i.e., uses the co-campaign as a regular campaign competing for advertising spaces in rendered web pages. Also, in one embodiment, a co-campaign may be configured to inherit all existing dimensions of an online advertisement campaign as well as additional features, such as those specified in FIG. 4.

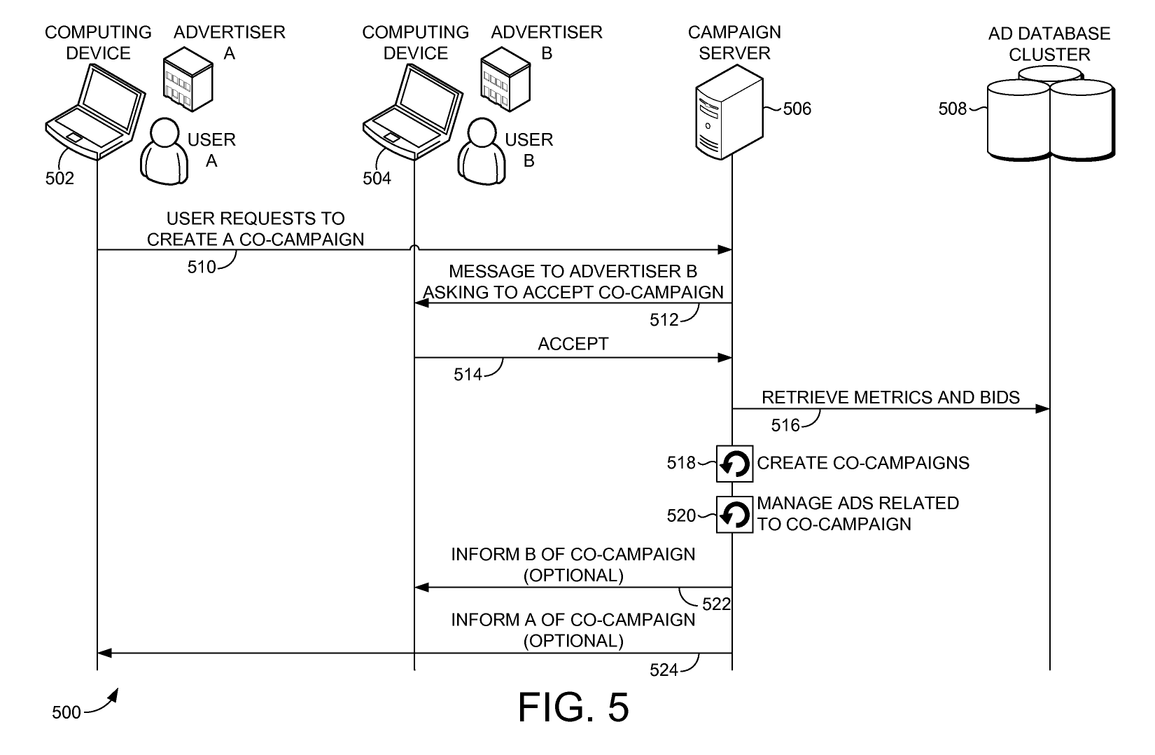

FIG. 5 further illustrates multiple advertisers interacting to create co-campaigns. Specifically, FIG. 5 is an interactive block diagram showing the flow of active between multiple devices in order to create and manage a co-campaign, according to one embodiment. Illustrated generally as flow 500, an interaction over a network is shown between computing devices 502 and 504, campaign server 506, and ad database cluster 508. It should be noted, however, that alternative embodiments may employ addition computing devices, servers, and/or databases. Thus, flow 500 is provided merely for explanatory purposes, illustrating merely one embodiment.

Flow 500 begins initially with user A submitting a request to create a co-campaign to the campaign server 506, as illustrated at 510. user A represents an employee of advertiser A, which is an advertiser trying to create a co-campaign with advertiser B. The co-campaign user request may include any selections of the options discussed previously—e.g., co-campaign name, partner advertiser, type of co-campaign, etc. Although not shown for the sake of clarity, the campaign server 506 may interact with computing device 502 in order to illicit different option selections. For example, the campaign server 506 may provide a list of potential partner advertisers to a computing device 502 so that user A can select the particular co-campaign entity that advertiser A wishes to create a co-campaign with. Eventually, the interaction of the campaign server 506 and computing device 502 will create a co-campaign request.

In response to the co-campaign request, the campaign server 506 sends a message to advertiser B asking for acceptance of the requested co-campaign. In one embodiment, the message includes an option for user B at advertiser B to accept, reject, or modify the co-campaign request. For example, advertiser B may only accept the co-campaign request from advertiser A if advertiser A's bid boost amount is greater than a certain amount of money. Or, in another example, the message may provide user B with a draft of a combo ad created by user A, including an image, flash file, or link to a document of the draft combo ad. User B can then modify the draft combo ad and send the modified combo ad back to user A and—through the campaign server 506—to see if user A will approve the modifications to the combo ad. In other words, the campaign server 506 may facilitate user A and user B passing modified combo ads until user A and user B reach an agreement on a finalized combo ad.

As illustrated at 514, user B may accept the co-campaign request from the campaign server 506, resulting in the campaign server 506 retrieving different metricses and bids from the ad database cluster 508 in order to create the co-campaign, as shown at 518. If advertiser A only request to bid boost a current campaign of advertiser B, the campaign server 506 retrieves the current metrics and bid amounts of the appropriate current campaign of advertiser B from the ad database cluster 508 and increments the bid amount currently stored by the bid boost amount specified in the co-campaign request from user A. For a combo ad, the campaign server 506 may simply store the agreed upon combo ad in the ad database cluster 508 and, additionally, store a combined bid amount from advertisers A and B in the ad database cluster 508. As for a metrics sharing co-campaign, the campaign server 506 may retrieve the metrics advertiser B has agreed to share with advertiser A from the ad database cluster 508.

Different embodiments may store created co-campaigns, or portions of created co-campaigns, in different places. In one embodiment, created co-campaigns are stored on the campaign server 506. Alternatively, created co-campaigns may be stored on the ad database cluster 508. Yet, in another embodiment, the campaign server 506 and the ad database cluster 508 are stored on the same server that stores different co-campaigns, campaigns, metrics, and/or bid amounts.

Once a co-campaign is created, campaign server 506 manages the created co-campaign, as shown at 520. When managing a created co-campaign, performs the campaign server 506 any of the aforementioned actions of a co-campaign. For example, the campaign server 506 may increment a current campaigns bid amount by a bid boost amount from advertiser A. In another example, a combo ad may be provided to a web advertising service along with different metricses and bid amounts from user A and user B. Still another example, in the case of a share metrics co-campaign the requested and approved metrics to be shared between advertiser A and advertiser B may be provided to user A or may simply be used by advertiser A to create its own co-campaign. These examples are provided merely for explanatory purposes and are not meant to limit the embodiments discussed herein.

Optionally, messages may be sent to user A and/or user B when a co-campaign is created. The messages may not only alert user A and user B about the creation of a co-campaign; the messages may also provide terms of the co-campaign, inform the Users of the duration of the co-campaign, provide instructions for modifying the co-campaign, or provide contact information of one user to another user. Also, if user A or B modify the co-campaign, all co-campaign participants may be notified of the change by the campaign server 506. All participants may also be allowed to freely view the co-campaign settings at any time or drop out of the co-campaign at any time. In an alternative embodiment, the co-campaign may create a contract between advertisers A and B that spans a certain time period. In this scenario, advertisers A and B may restricted from changing the co-campaign settings during the time period.

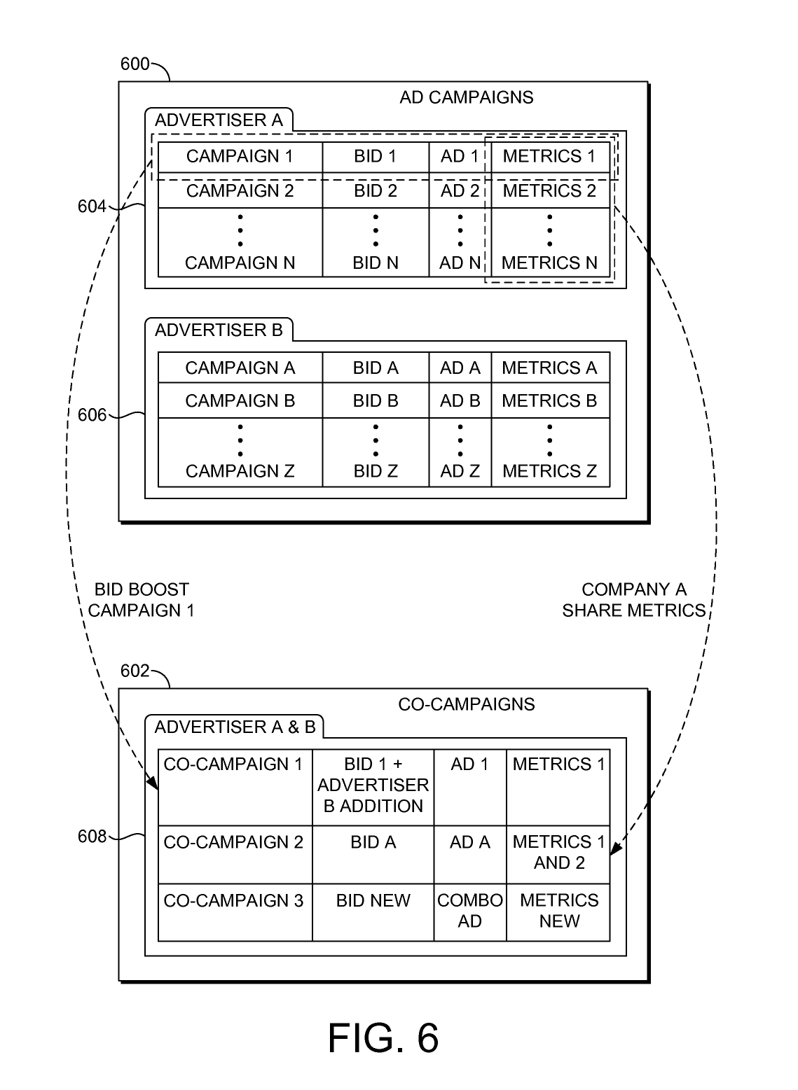

FIG. 6 illustrates a tabular representation of ad campaigns and co-campaigns, according to one embodiment. FIG. 6 shows tabular representations of ad campaigns 600 and co-campaigns 602 stored in the memory of different servers. In particular, the ad campaign 600 comprises different campaigns from advertiser A 604 and different campaigns from advertiser B 606. For instances, the campaigns 604 for advertiser A include campaigns 1, 2, and so on to campaign N, with each campaign comprising different bids, advertisements, and other metrics. Taking campaign 1 as an example, campaign 1 may be stored with bid amounts 1, advertisement 1, and varying metrics 1. Likewise, campaign 2 for advertiser A may also have its own bid amount, advertisement, and metrics. The same can also be said for campaigns A, B, and so on to Z for advertiser B.

Upon creation, co-campaigns 608 may be stored separately from the campaigns of advertisers A and B. As illustrated, co-campaigns 1 and 2 represent co-campaigns created for advertisers A and B. Specifically, co-campaign 1 shows a bid boost co-campaign that, when stored, includes a bid amount (bid 1) from a previous campaign (campaign 1) incremented by a bid addition from an advertiser (advertiser B) with no affiliation to the campaign (campaign 1). The resultant co-campaign created therefore includes the co-campaign name (co-campaign 1), bid amount (bid 1 plus advertiser B's addition), advertisement (ad 1), and user-profile metric (metric 1).

Co-campaign 2 represents a share-metrics campaign between advertisers A and B. For co-campaign 2, the different metrics (metrics 1, 2, and N) are combined and associated with the co-campaign. While co-campaign 2 is shown to include all of the metrics of all the campaigns for advertiser A, such may not be the case for alternative embodiments. For instance, advertiser B may only wish to use the metrics of advertiser A with respect to advertisements for a particular product of advertiser A. In that case, the combined metrics in the co-campaign may only include the metrics used in varying campaigns of advertiser A for that particular product, and not metrics used for campaigns of other products.

Furthermore, in the case of a combo ad co-campaign (co-campaign 3), the created combo ad may be stored, along with existing or new bid amounts and metrics agreed upon by advertisers A and B. For example, advertisers A and B may work together to create a combo ad and then agree upon appropriate bid amounts and metrics to use for the combo ad, as well as which entity is paying which percentage of the agreed on bid amounts. Alternatively, one particular advertiser may give the other advertiser free reign when choosing the bid amounts or metrics to use for the combo ad. Numerous other examples for structuring combo ad co-campaigns may also be used and stored.

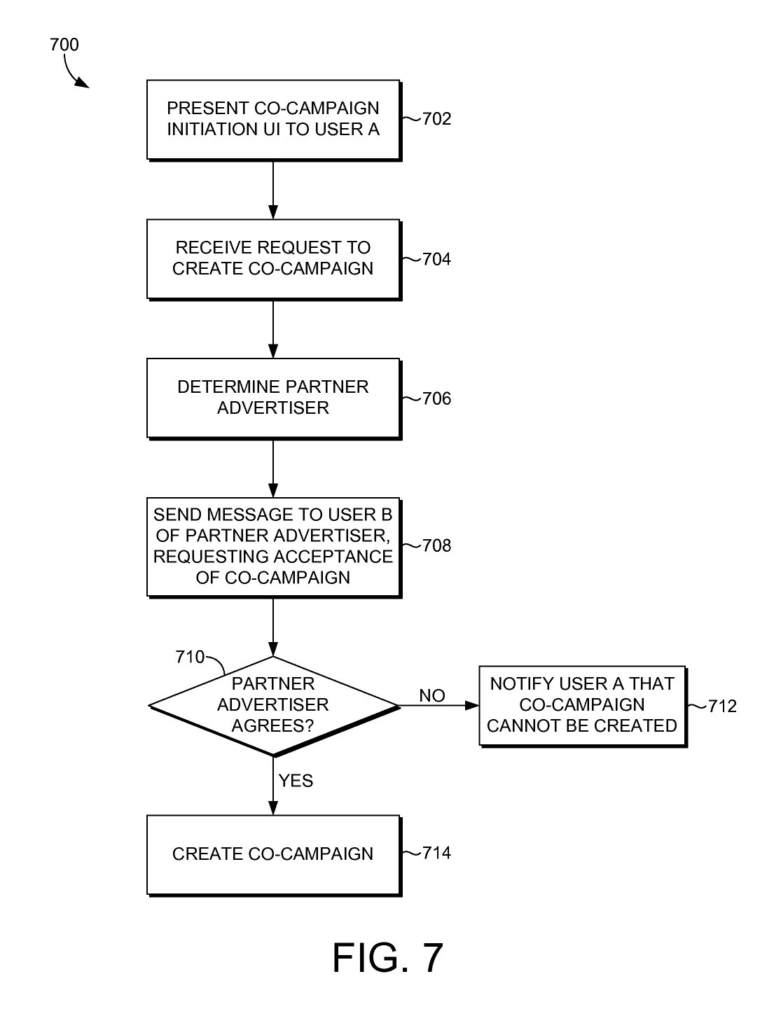

FIG. 7 is a diagram of a flow chart for creating a co-campaign, according to one embodiment. The illustrated embodiment, generally references as flow 700, initiates by presenting a co-campaign initiation UI to a user (user A) as illustrated at 702. For instances, user A may navigate to a web page for creating co-campaigns, and the web page may be equipped with several interactive options for the user to select or enter information about the co-campaign. These options have been discussed somewhat at length above, for example in reference to FIG. 4.

Once the user has used the options to indicate what kind of co-campaign to create, the user may submit a request to create the co-campaign to an application server. When the application server receives the request, as shown at 704, the application server determines a partner advertiser for the co-campaign, as shown at 706. A “partner advertiser” as referred to herein, is an additional entity other than the entity seeking to create a co-campaign. For example, advertiser B in FIGS. 3-5 would be considered a partner advertiser of advertiser A. Partner advertisers may be determined in different ways. For example, the partner advertiser may be specified by user A on the co-campaign initiation UI. Alternatively, user A may request to look up or search for the partner advertiser, which may trigger the application server to perform keyword or context-based searching for names of entities specified by user A on the co-campaign initiation UI. In another embodiment, however, the application server may provide a look-up or search feature for potential partner advertisers because the application server may be configured to keep the names of other advertisers secret.

A message may be sent to user B of the determined partner advertiser, asking user B whether the partner advertiser will agree to create a co-campaign with user A's advertiser. Such is shown at 708. If user B agrees to the co-campaign on the partner advertiser's behalf, as shown at 710, the co-campaign is created by the application server, as shown at 714. On the other hand, if user B rejects the request, no co-campaign is created and user A is notified of the rejection, as shown at 712.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media embodied with computer-executable instructions that, when executed by a processor, create and store a co-campaign between advertisers, comprising:
receiving, on an application server, a request submitted by a user to create the co-campaign between a first advertiser and a partner advertiser, wherein the advertising co-campaign comprises a web advertisement, bid amount, and plurality of user-profile metrics;
determining the partner advertiser from the request;
sending a message to a second user, who is affiliated with the partner advertiser, informing the second user that the first advertiser wishes to create the co-campaign with the partner advertiser;
receiving an indication that the partner advertiser agrees to create the co-co-campaign;
creating the co-campaign because of the indication; and
storing the co-campaign.

2. The one or more media of claim 1, wherein the co-campaign comprises a bid amount designated by the partner advertiser and a bid-boost amount designated by the first advertiser.

3. The one or more media of claim 1, wherein the co-campaign comprises a combo advertisement (combo ad) created by the first advertiser and the partner advertiser.

4. The one or more media of claim 3, wherein the combo ad comprises at least member of a group comprising an mark-up language file, Flash file, image file, and link to a location of a file.

5. The one or more media of claim 1, wherein the advertisement template comprises at least one member of a group comprising an indication of animation and a hyperlink to web content that is contextually relevant to the text-based advertisement.

6. The one or more media of claim 1, wherein the request is transmitted from a computing device to the application server over a network.

7. The one or more media of claim 1, wherein the co-campaign comprises a share-metrics co-campaign that includes user-profile metrics currently being used by the partner advertiser in an online advertising campaign.

8. The one or more media of claim 1, wherein determining the partner advertiser from the request further comprises:
parsing one or more keywords from the request;
querying a database to determine one or more entities associated with the one or more keywords; and
transmitting the one or more entities to a computing device for selection by the user.

9. The one or more media of claim 1, wherein the message is at least one member of a group comprising an e-mail, SMS, and MMS message with an option to agree to create the co-campaign.

10. A computer-implemented method, performed by an application server, for creating a co-campaign advertisement between a first advertiser and a partner advertiser, comprising:
across a network, receiving a request submitted by a user Accessing a co-campaign initiation UI window to create the co-campaign between the first advertiser and the partner advertiser, wherein the request comprises at least member of a group comprising a bid-boost increment, draft combo advertisement (combo ad), and share-metrics message;
determining the partner advertiser from the request;
sending a message to a second user, who is affiliated with the partner advertiser, informing the second user that the first advertiser wishes to create the co-campaign with the partner advertiser;
receiving an indication from the second user agreeing to create the co-campaign; and
creating the co-campaign; and
storing, in association with both the first advertiser and the partner advertiser, the co-campaign stored with a related a bid amount, advertisement, and plurality of user-profile metrics related to the co-campaign are stored.

11. The computer-implemented method of claim 10, further comprising:
selecting the co-campaign based on the bid amount and the user-profile metrics; and
transmitting the advertisement of the co-campaign for display in a rendering of a web page in an advertisement space of the web page.

12. The computer-implemented method of claim 11, wherein the bid amount comprises a campaign bid amount associated with a campaign currently stored for a partner advertiser and a bid-boost increment from the first advertiser.

13. The computer-implemented method of claim 10, wherein the combo ad comprises a draft of an online advertisement created by the user.

14. The computer-implemented method of claim 12, further comprising:
sending a second message to the user that includes a modified version of the draft of the online advertisement;
receiving, from the user, an acceptance of the modified version; and
including the modified version in the co-campaign; and
storing the modified version in association with the co-campaign.

15. The computer-implemented method of claim 10, wherein the bid amount of the co-campaign comprises a campaign bid amount associated with a campaign currently stored for a partner advertiser and a bid-boost increment from the first advertiser.

16. The computer-implemented method of claim 10, wherein the user-profile metrics comprise stored demographic information about users who search the World Wide Web.

17. The computer-implemented method of claim 10, wherein the demographic information comprises at least member of a group comprising a click-thru rate (CTR), bid amount, advertisement design, advertisement layout, viewer's ages, viewer's locations, viewer's genders, viewer's races, and viewer's web histories.

18. A computer-implemented method, performed by an application server, for creating a co-campaign advertisement between a first advertiser and a partner advertiser, comprising:
receiving a request to create the co-campaign, wherein the request comprises an indication that the first advertiser will boost the bid amount of one or more campaigns associated with the partner advertiser By a bid-boost amount;
sending a message to a second user informing the second user that the first advertiser is willing to boost the bid amount of the one or more campaigns by the bid-boost amount;
receiving notice that the second user Agrees to create the co-campaigns; and
creating the co-campaign with a new bid amount, advertisement, and a plurality of user-profile metrics, wherein the new bid amount comprises the bid amount and the bid-boost amount; and
storing the co-campaign.

19. The one or more media of claim 18, wherein the bid-boost amount includes a dollar value and a time from during which the bid amount will be boosted by the dollar value.

20. The one or more media of claim 19, wherein the one or more campaigns include only online advertising campaigns directed towards a particular product of the partner advertiser.
